(19) United States
(12) Patent Application Publication
(10) Pub. No.: US 2026/0128657 A1
(43) Pub. Date: May 7, 2026

(54) STEP MOTOR

(71) Applicant: AAC Microtech (Changzhou) Co., Ltd., Changzhou City (CN)

(72) Inventors: Feng Yan, Changzhou (CN); Junxiang Han, Changzhou (CN); Junsheng Wang, Changzhou (CN)

(21) Appl. No.: 19/036,049

(22) Filed: Jan. 24, 2025

Related U.S. Application Data
(63) Continuation of application No. PCT/CN2024/130215, filed on Nov. 6, 2024.

(51) Int. Cl. H02K 37/24; H02K 7/08; H02K 7/116; H02K 37/14; H02K 37/22

(52) U.S. Cl. CPC H02K 37/24; H02K 7/083; H02K 7/1166; H02K 37/14; H02K 37/22

(57) ABSTRACT

Provided is a step motor including a housing, a stator assembly, a rotor assembly, and a reduction gearbox assembly. The housing includes an outer shell as well as a first end cover and a second end cover, and the rotor assembly includes a rotary shaft and a permanent magnet. The step motor further includes an elastic piece fixed to the first end cover, the elastic piece includes a limiting portion, a ring-shaped fixing portion arranged around the limiting portion, and at least two elastic arms connecting the limiting portion with the fixing portion, and the fixing portion is fixed to the first end cover. Compared with the related art, the step motor of the present disclosure has high transmission precision, a small backlash, good vibration damping and noise reduction capabilities, as well as small volume occupation and low cost.

### TECHNICAL FIELD

The present disclosure relates to the technical field of motors, and in particular, to a step motor.

### BACKGROUND

Step motors have been widely used in the fields of electric motors, electric generators and the like due to their compact structure, high power density, high work efficiency, and significant energy saving and consumption reduction benefits. In recent years, there is an increasingly urgent demand in the industrial field for devices that utilize step motors to directly drive loads for work, and the widespread application of these step motor direct-drive devices will produce immeasurable energy-saving benefits.

In related technologies, most of the step motors include an outer shell, a rotor, and a stator arranged around the rotor at intervals, as well as a gearbox, a motor rotation is realized by mutual driving of the stator and the rotor, and the gearbox is driven by an output shaft of the motor for power transmission. The stator includes a winding fixed to an outer peripheral side of the outer shell, the rotor generally includes a rotary shaft and a magnet fixed to an outer peripheral side of the rotary shaft, and the motor rotation is realized by mutual driving of the magnet and the winding. However, for the gearbox structure in the related technologies, when the motor is subjected to axial force, the movement of the shaft of the motor will cause a significant reduction in power transmission precision (which is accumulated when changing direction), and at the moment of starting, an end of the shaft moves rapidly due to the force and hits the fixing members, thus generating noise. In order to reduce the noise, a single-arm elastic piece formed by stamping is arranged on one side of the outer shell, and the single-arm elastic piece abuts against the end of the rotary shaft and its outer side is fixed to the outer shell. However, the single-arm elastic piece is prone to failure in the position near the root portion or welding point peeling in the long-term stress state. Moreover, since it requires a bending process, its structural features are relatively complex, which leads to an increase in production costs. Furthermore, during the handling process, it is easy to deform. When in use, it may be subjected to unilateral force. In addition, it has high thickness requirements, poor design flexibility, as well as insufficient reliability.

Therefore, it is necessary to provide a novel step motor to solve the above technical problems.

### SUMMARY

Objectives of the present disclosure are to provide a step motor that has higher power transmission precision, realizes a smaller backlash and better vibration damping, as well as noise reduction capabilities. In addition, it has a small volume occupation and low cost.

In order to achieve the above objectives, the present disclosure provides a step motor including a housing, a stator assembly fixed to an inner peripheral side of the housing, a rotor assembly supported by the housing and rotationally connected to with the housing, and a reduction gearbox assembly connected to an output end of the rotor assembly for power transmission; where the stator assembly is arranged around the rotor assembly and spaced apart from the rotor assembly, the housing includes an outer shell as well as a first end cover and a second end cover respectively fixed to both ends of the outer shell, the reduction gearbox assembly is fixed on a side of the second end cover away from the outer shell, the rotor assembly includes a rotary shaft rotationally connected to with the first end cover and the second end cover, respectively, as well as a permanent magnet sleeved on and fixed to the rotary shaft, and an outer peripheral side of the permanent magnet is spaced apart from the stator assembly; and where the step motor further includes an elastic piece having a flat plate structure and fixed to the first end cover, the elastic piece includes a limiting portion abutting against an end of the rotary shaft away from the reduction gearbox assembly, a ring-shaped fixing portion arranged around the limiting portion, and at least two elastic arms connecting the limiting portion with the fixing portion, and the fixing portion is fixed to the first end cover.

As an improvement, the limiting portion has a circular structure and is located in the center of the fixing portion, and the number of the elastic arms is three, and the three elastic arms are arranged in a centrally symmetrical manner about the center of the limiting portion.

As an improvement, a width of each of the elastic arms decreases gradually from both ends towards the middle.

As an improvement, each of the elastic arms is in an arc shape.

As an improvement, the step motor further includes a first bearing and a second bearing arranged opposite to each other, an inner peripheral side of the first bearing is sleeved on and fixed to the end of the rotary shaft away from the reduction gearbox assembly, an outer peripheral side of the first bearing is inserted into and fixed to the first end cover, and a side of the first bearing away from the permanent magnet abuts against the limiting portion; and an inner peripheral side of the second bearing is sleeved on and fixed to an end of the rotary shaft close to the reduction gearbox assembly, an outer peripheral side of the second bearing is inserted into and fixed to the second end cover, and an end of the reduction gearbox assembly close to the housing is sleeved on the second bearing.

As an improvement, the housing further includes a claw-pole inserted into and fixed to the outer shell, the claw-pole and the outer shell together enclose to form a mounting site, the stator assembly is sleeved in and fixed to the outer shell, and is located in the mounting site, the step motor further includes a framework fixed to the housing, and the framework includes an annular framework body and a connecting portion extending along a direction perpendicular to an axial direction of the rotary shaft from the framework body, the framework body fixes the outer shell and is located in the mounting site, and the stator assembly is sleeved on and fixed to an outer peripheral side of the framework.

As an improvement, the step motor further includes a circuit board assembly fixed to an end of the connecting portion away from the outer shell.

As an improvement, the step motor further includes a first spacer and a second spacer, the first spacer and the second spacer are respectively attached and fixed to opposite ends of the permanent magnet, and the first spacer is spaced apart from the first end cover and the second spacer is spaced apart from the second end cover.

As an improvement, the rotary shaft includes a rotary shaft body rotationally connected to with the first end cover and the second end cover, respectively, a rotary shaft extension extending from the rotary shaft body into the reduction gearbox assembly, a limiting member formed by an outer peripheral side of the rotary shaft extension recessing radially inwards and a screw sleeved on and fixed to the limiting member, and the reduction gearbox assembly includes a box for fixing the second end cover, a rotating shaft arranged in the box and rotationally connected to, and a gear sleeved on and fixed to the rotating shaft, the rotating shaft is arranged perpendicularly to the rotary shaft, and the gear forms a threaded connection with the screw.

As an improvement, the step motor further includes a vibration damping block fixed in the box, and an end of the rotary shaft extension away from the rotary shaft body abuts against the vibration damping block.

Compared with the related art, in the step motor of the present disclosure, the stator assembly is fixed in the housing, the rotor assembly forms the rotational connection with the housing, the stator assembly is arranged around the rotor assembly and spaced apart from the rotor assembly; the magnetic fields generated by the stator assembly and the rotor assembly drive each other to drive the reduction gearbox assembly for power transmission; the stator assembly is sleeved in and fixed to the outer shell and located in the mounting site, the reduction gearbox assembly is fixed on the side of the second end cover away from the outer shell, and the rotor assembly forms the rotational connection with the first end cover and the second end cover, respectively; the rotor assembly includes the rotary shaft forming the rotational connection with the first end cover and the second end cover, respectively, and the permanent magnet sleeved on and fixed to the rotary shaft, and the outer peripheral side of the permanent magnet is spaced apart from the stator assembly; the step motor further includes the elastic piece which is of a flat plate structure and fixed to the first end cover, the elastic piece includes the limiting portion abutting against the end of the rotary shaft away from the reduction gearbox assembly, the ring-shaped fixing portion arranged around the limiting portion, and the at least two elastic arms connecting the limiting portion with the fixing portion; the fixing portion is fixed to the first end cover; by abutting the limiting portion of the elastic piece against the rotary shaft, the fixing portion is fixed to the first end cover, a smaller smaller backlash and better vibration damping, as well as noise reduction capabilities are realized by the elastic arms, Moreover, it has the advantages of small volume occupation, low cost and the like, and is highly popularizable.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a three-dimensional structure of a step motor provided by an embodiment of the present disclosure.

FIG. 2 is an exploded view of the three-dimensional structure of a step motor provided by the embodiment of the present disclosure.

FIG. 3 is a cross-sectional view along a line A-A in FIG. 1.

FIG. 4 is a structural schematic view of an elastic piece provided by an embodiment of the present disclosure.

Reference signs: 100—step motor, 1—housing, 11—outer shell, 12—first end cover, 13—second end cover, 14—claw-pole, 15—mounting site, 2—stator assembly, 3—rotor assembly, 31—permanent magnet, 32—rotary shaft, 321—rotary shaft body, 322—limiting member, 323—screw, 324—rotary shaft extension, 4—reduction gearbox assembly, 41—box, 42—rotating shaft, 43—gear, 5—elastic piece, 51—limiting portion, 52—elastic arm, 53—fixing portion, 6—first bearing, 7—second bearing, 8—framework, 81—framework body, 82—connecting portion, 9—circuit board assembly, 10—first spacer, 2—second spacer, 30—vibration damping block.

### DESCRIPTION OF EXAMPLES

The technical solutions in embodiments of the present disclosure will be described clearly and completely below in conjunction with the accompanying drawings. It is apparent that the described embodiments are only a part of the embodiments of the present disclosure and not all of the embodiments. Based on the embodiments in the present disclosure, all other embodiments obtained by those of ordinary skill in the art without creative labor are within the protection scope of the present disclosure.

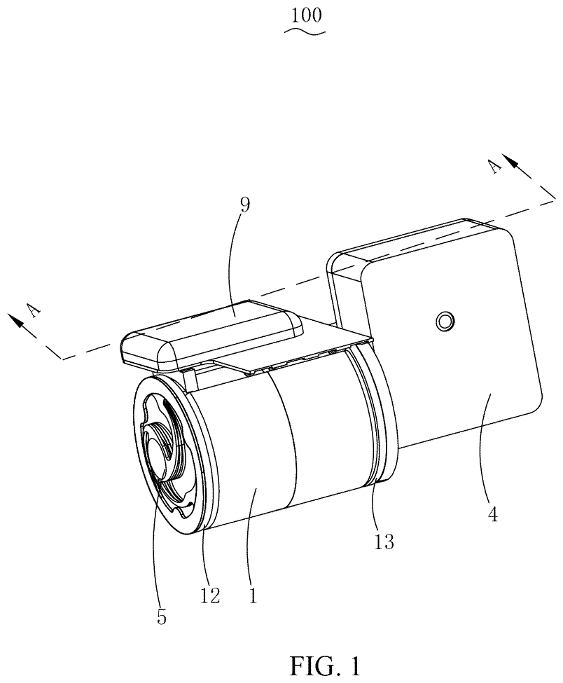

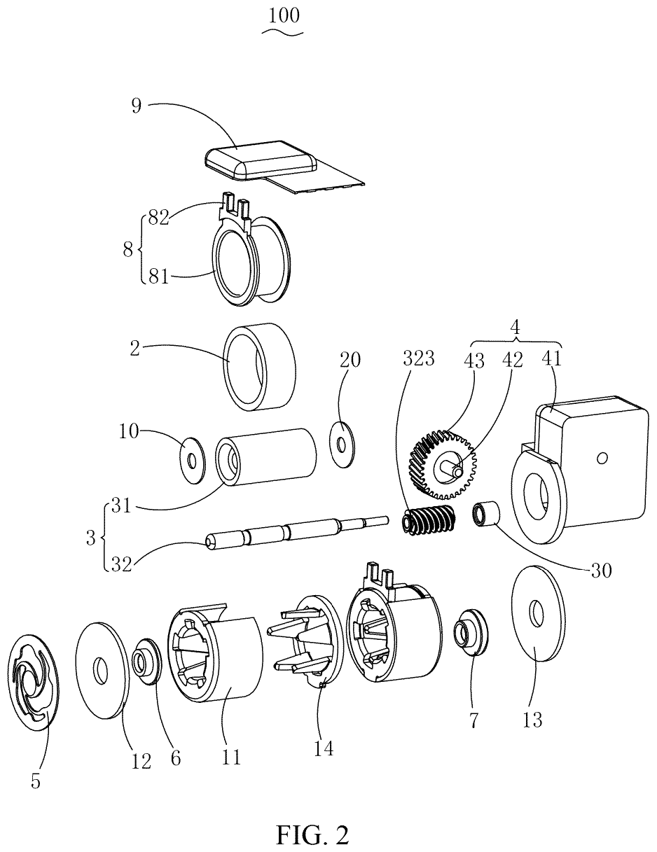

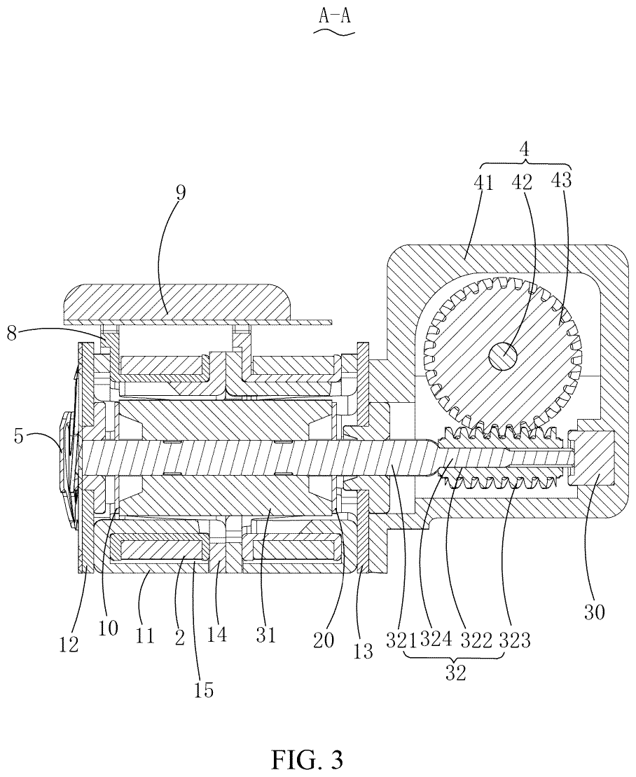

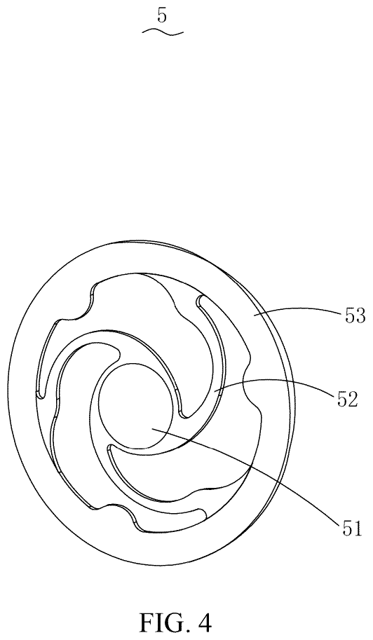

As shown in conjunction with FIGS. 1 to 4, an embodiment of the present disclosure provides a step motor 100 including a housing 1, a stator assembly 2 fixed to an inner peripheral side of the housing 1, a rotor assembly 3 supported by the housing 1 and rotationally connected to with the housing 1, and a reduction gearbox assembly 4 connected to an output end of the rotor assembly 3 for power transmission. The stator assembly 2 is arranged around the rotor assembly 3 and spaced apart from the rotor assembly 3. The housing 1 includes an outer shell 11 as well as a first end cover 12 and a second end cover 13 respectively fixed to both ends of the outer shell 11, the stator assembly 2 is sleeved in and fixed to the outer shell 11 and located in a mounting site 15, the reduction gearbox assembly 4 is fixed on a side of the second end cover 13 away from the outer shell 11, and the rotor assembly 3 forms a rotational connection with the first end cover 12 and the second end cover 13, respectively. The housing 1 is used for fixing the first end cover 12 and the second end cover 13.

In some embodiments, the stator assembly 2 is a coil winding, and the coil winding is arranged around the rotor assembly 3. Optionally, the number of the stator assemblies 2 may be at least two, and the two stator assemblies 2 are arranged side by side along an axial direction of a rotary shaft 32.

The rotor assembly 3 includes a rotary shaft 32 rotationally connected to with the first end cover 12 and the second end cover 13, respectively, and a permanent magnet 31 sleeved on and fixed to the rotary shaft 32, and an outer peripheral side of the permanent magnet 31 is spaced apart from the stator assembly 2. The rotation of the rotary shaft 32 is realized by the mutual driving of the magnetic fields generated by the permanent magnet 31 and the stator assembly 2, so as to drive the reduction gearbox assembly 4 to move by the rotary shaft 32.

The step motor 100 further includes an elastic piece 5 which is of a flat plate structure and fixed to the first end cover 12, the elastic piece 5 includes a limiting portion 51 abutting against an end of the rotary shaft 32 away from the reduction gearbox assembly 4, a ring-shaped fixing portion 53 arranged around the limiting portion 51, and at least two elastic arms 52 connecting the limiting portion 51 with the fixing portion. The fixing portion 53 is fixed to the first end cover 12. By abutting the limiting portion 51 of the elastic piece 5 against the rotary shaft 32, the fixing portion 53 is fixed to the first end cover 12, a smaller smaller backlash and better vibration damping, as well as noise reduction capabilities are realized by the elastic arms 52. Moreover, it has the advantages of small volume occupation, low cost and the like, and is highly popularizable. Further, through the introduction of the planar elastic piece 5, the clearance of the rotor assembly 3 of the motor and the accumulated errors of the parts are effectively eliminated, ensuring that the system is maintained at a high level of transmission precision and low noise performance. In addition, the elastic piece 5 can provide shock-absorption during a fall, improving the reliability of the mechanism. It is stressed all around during the usage process, with a low risk of failure, and it has high design flexibility and can reduce the thickness, thus occupying less volume.

In some embodiments, the fixing portion 53 is fixed to the first end cover 12 by a process such as welding and the like.

In some embodiments, the limiting portion 51 is of a circular structure and is located in the center of the fixing portion 53, and the number of the elastic arms 52 is three, and the three elastic arms 52 are arranged in a centrally symmetrical manner about the center of the limiting portion 51.

In some embodiments, the number of the elastic arms 52 is two or more. Optionally, the number n≥3. For example, the number is 3, and the actual number is not limited. Two ends of each of the elastic arms 52 are respectively connected to the inner circular limiting portion 51 and the outer annular fixing portion 53, and the elastic arms 5 are arranged centrosymmetrically about the center of the limiting portion 51, so as to ensure that the mechanism is subjected to force symmetrically and has better stability and reliability.

In some embodiments, a width of each of the elastic arms 52 decreases gradually from both ends towards the middle, so that better stress performance is ensured.

In some embodiments, each of the elastic arms 52 is in an arc shape. The arce-shaped structure (connecting rib structure) is generally a structure designed to be gradually narrowed in width from the ends to the middle, so as to ensure better stress performance. A certain degree of axial pre-tightening force is provided by the arce-shaped design, and this pre-tightening force is optionally designed to be greater than an axial force towards the left (a side away from the reduction gearbox assembly 4) given by a gear 43 to which the rotary shaft 32 is subjected during the load transmission, to ensure that the system is stabilized at a very high transmission precision.

In some embodiments, the step motor 100 further includes a first bearing 6 and a second bearing 7 arranged opposite to each other. An inner peripheral side of the first bearing 6 is sleeved on and fixed to an end of the rotary shaft 32 away from the reduction gearbox assembly 4, an outer peripheral side of the first bearing 6 is inserted into and fixed to the first end cover 12, and a side of the first bearing 6 away from the permanent magnet 31 abuts against the elastic arms 52. By abutting the elastic arms 52 against the end of the first bearing 6, a better torque output of the motor can be ensured, but its use scenarios are not limited, for example, if the elastic arms 52 are set to abut against the end of the rotary shaft 32, it still belongs to the scope protection of the present discloure.

An inner peripheral side of the second bearing 7 is sleeved on and fixed to an end of the rotary shaft 32 close to the reduction gearbox assembly 4, an outer peripheral side of the second bearing 7 is inserted into and fixed to the second end cover 13, and an end of the reduction gearbox assembly 4 close to the housing 1 is sleeved on the second bearing 7. The first bearing 6 and the second bearing 7 are sleeved on the two ends of the rotary shaft 32, which results in low friction force and low loss of rotating power during the rotation of the rotary shaft 32, and high output precision of the motor.

In some embodiments, the housing 1 further includes a claw-pole 14 inserted into and fixed to the outer shell 11. The claw-pole 14 and the outer shell 11 together enclose to form the mounting site 15. The stator assembly 2 is sleeved in and fixed to the outer shell 11 and is located in the mounting site 15. The step motor 100 further includes a framework 8 fixed to the housing 1. The framework 8 includes an annular framework body 81 and a connecting portion 82 extending along a direction perpendicular to an axial direction of the rotary shaft 32 from the framework body 81. The framework body 81 fixes the outer shell 11 and is located in the mounting site 15, and the stator assembly 2 is sleeved on and fixed to an outer peripheral side of the framework 8. By fixing the framework body 81 to the stator assembly 2, the stator assembly 2 shows high stability during the driving of the rotor assembly 3. By inserting the claw-pole 14 into the housing 1 to form the mounting site 15, it is convenient for the surrounding installation of the stator assembly 2.

In some embodiments, the step motor 100 further includes a circuit board assembly 9 fixed to an end of the connecting portion 82 away from the outer shell 11. By using the circuit board assembly 9 for providing supply power to the stator assembly 2, the stator assembly 2 is driven to generate a magnetic field, which is convenient for the formation of a mutual driving with the rotor assembly 3 to drive the rotary shaft 32 to rotate.

In some embodiments, the step motor 100 further includes a first spacer 10 and a second spacer 20. The first spacer 10 and the second spacer 20 are respectively attached and fixed to opposite ends of the permanent magnet 31, and the first spacer 10 is spaced apart from the first end cover 12 and the second spacer 20 is spaced apart from the second end cover 13, so that the fixing effect of the permanent magnet 31 is improved.

In some embodiments, the rotary shaft 32 includes a rotary shaft body 321 rotationally connected to with the first end cover 12 and the second end cover 13, respectively, a rotary shaft extension 324 extending from the rotary shaft body 321 into the reduction gearbox assembly 4, a limiting member 322 formed by an outer peripheral side of the rotary shaft extension 324 recessing radially inwards, and a screw 323 sleeved on and fixed to the limiting member 322.

The reduction gearbox assembly 4 includes a box 41 for fixing the second end cover 13, a rotating shaft 42 arranged in the box 41 and rotationally connected to, and a gear 43 sleeved on and fixed to the rotating shaft 42. The rotating shaft 42 is arranged perpendicularly to the rotary shaft 32, and the gear 43 forms a threaded connection with the screw 323. The rotation of the screw 323 is driven by the rotation of the rotary shaft 32 to drive the rotation of the gear 43, and the speed reducer function is realized by the rotation of the gear 43.

In some embodiments, the step motor 100 further includes a vibration damping block 30 fixed in the box 41, and an end of the rotary shaft extension 324 away from the rotary shaft body 321 abuts against the vibration damping block 30. During a fall or impact, the rotary shaft 32 moves instantaneously towards the side away from the reduction gearbox assembly 4, and the elastic piece 5 is deformed to provide shock-absorbing buffering, which ensures the reliability of the structure at the end of gear 43. The design and optimization of the elastic arms 52 ensures that they are in the best elastic deformation interval.

In some embodiments, the vibration damping block 30 is made of silicone material, and thus has high structural strength and good damping effect.

Compared with the related art, in the step motor of the present disclosure, the stator assembly is fixed in the housing, the rotor assembly forms the rotational connection with the housing, the stator assembly is arranged around the rotor assembly and spaced apart from the rotor assembly; the magnetic fields generated by the stator assembly and the rotor assembly drive each other to drive the reduction gearbox assembly for power transmission; the stator assembly is sleeved in and fixed to the outer shell and located in the mounting site, the reduction gearbox assembly is fixed on the side of the second end cover away from the outer shell, and the rotor assembly forms the rotational connection with the first end cover and the second end cover, respectively; the rotor assembly includes the rotary shaft forming the rotational connection with the first end cover and the second end cover, respectively, and the permanent magnet sleeved on and fixed to the rotary shaft, and the outer peripheral side of the permanent magnet is spaced apart from the stator assembly; the step motor further includes the elastic piece which is of a flat plate structure and fixed to the first end cover, the elastic piece includes the limiting portion abutting against the end of the rotary shaft away from the reduction gearbox assembly, the ring-shaped fixing portion arranged around the limiting portion, and the at least two elastic arms connecting the limiting portion with the fixing portion; the fixing portion is fixed to the first end cover; by abutting the limiting portion of the elastic piece against the rotary shaft, the fixing portion is fixed to the first end cover, a smaller smaller backlash and better vibration damping, as well as noise reduction capabilities are realized by the elastic arms, Moreover, it has the advantages of small volume occupation, low cost and the like, and is highly popularizable.

The above described is only the implementations of the present disclosure, it should be pointed out here that, for those of ordinary skill in the art, improvements can also be made without departing from the inventive concept of the present disclosure, but these all are within the protection scope of the present disclosure.

What is claimed is:

1. A step motor, comprising a housing, a stator assembly fixed to an inner peripheral side of the housing, a rotor assembly supported by the housing and rotationally connected to the housing, and a reduction gearbox assembly connected to an output end of the rotor assembly for power transmission;
wherein the stator assembly is arranged around the rotor assembly and spaced apart from the rotor assembly, the housing comprises an outer shell and a first end cover and a second end cover respectively fixed to both ends of the outer shell, the reduction gearbox assembly is fixed on a side of the second end cover away from the outer shell, the rotor assembly comprises a rotary shaft rotationally connected to the first end cover and the second end cover, respectively, as well as a permanent magnet sleeved on and fixed to the rotary shaft, and an outer peripheral side of the permanent magnet is spaced apart from the stator assembly; and
wherein the step motor further comprises an elastic piece having a flat plate structure and fixed to the first end cover, the elastic piece comprises a limiting portion abutting against an end of the rotary shaft away from the reduction gearbox assembly, a ring-shaped fixing portion arranged around the limiting portion, and at least two elastic arms connecting the limiting portion with the fixing portion, and the fixing portion is fixed to the first end cover.

2. The step motor as described in claim 1, wherein the limiting portion has a circular structure and is located in the center of the fixing portion, the number of the elastic arms is three, and the three elastic arms are arranged in a centrally symmetrical manner about the center of the limiting portion.

3. The step motor as described in claim 2, wherein a width of each of the elastic arms decreases gradually from both ends towards the middle.

4. The step motor as described in claim 3, wherein each of the elastic arms is in an arc shape.

5. The step motor as described in claim 1, wherein the step motor further comprises a first bearing and a second bearing, an inner peripheral side of the first bearing is sleeved on and fixed to the end of the rotary shaft away from the reduction gearbox assembly, an outer peripheral side of the first bearing is inserted into and fixed to the first end cover, and a side of the first bearing away from the permanent magnet abuts against the limiting portion; and
an inner peripheral side of the second bearing is sleeved on and fixed to an end of the rotary shaft close to the reduction gearbox assembly, an outer peripheral side of the second bearing is inserted into and fixed to the second end cover, and an end of the reduction gearbox assembly close to the housing is sleeved on the second bearing.

6. The step motor as described in claim 1, wherein the housing further comprises a claw-pole inserted into and fixed to the outer shell, the claw-pole and the outer shell together enclose to form a mounting site, the stator assembly is sleeved on and fixed to the outer shell, and is located in the mounting site;
the step motor further comprises a framework fixed to the housing, the framework comprises an annular framework body and a connecting portion extending along a direction perpendicular to an axial direction of the rotary shaft from the framework body, the framework body fixes the outer shell and is located in the mounting site, and the stator assembly is sleeved on and fixed to an outer peripheral side of the framework.

7. The step motor as described in claim 6, wherein the step motor further comprises a circuit board assembly fixed to an end of the connecting portion away from the outer shell.

8. The step motor as described in claim 1, wherein the step motor further comprises a first spacer and a second spacer, the first spacer and the second spacer are respectively attached and fixed to opposite ends of the permanent magnet, and the first spacer is spaced apart from the first end cover and the second spacer is spaced apart from the second end cover.

9. The step motor as described in claim 1, wherein the rotary shaft comprises a rotary shaft body rotationally connected to with the first end cover and the second end cover, respectively, a rotary shaft extension extending from the rotary shaft body into the reduction gearbox assembly, a limiting member formed by an outer peripheral side of the rotary shaft extension recessing radially inwards and a screw sleeved on and fixed to the limiting member; and
the reduction gearbox assembly comprises a box for fixing the second end cover, a rotating shaft arranged in the box and rotationally connected to, and a gear sleeved on and fixed to the rotating shaft, the rotating shaft is arranged perpendicularly to the rotary shaft, and the gear forms a threaded connection with the screw.

10. The step motor as described in claim 9, wherein the step motor further comprises a vibration damping block fixed in the box, and an end of the rotary shaft extension away from the rotary shaft body abuts against the vibration damping block.
